(19) United States
(12) Patent Application Publication
(10) Pub. No.: US 2021/0121028 A1
(43) Pub. Date: Apr. 29, 2021

(54) ROBOT CLEANER

(71) Applicant: LG ELECTRONICS INC., Seoul (KR)

(72) Inventors: Chulmo SUNG, Seoul (KR); Hyungjin JEON, Seoul (KR)

(21) Appl. No.: 17/047,157

(22) PCT Filed: Apr. 12, 2019
(86) PCT No.: PCT/KR2019/004405

§ 371 Date: Oct. 13, 2020

(30) Foreign Application Priority Data
Apr. 13, 2018 (KR) 10-2018-0043035

(51) Int. Cl. A47L 9/00; A47L 9/28

(52) U.S. Cl. CPC A47L 9/009; A47L 9/2852; B25J 11/0085; A47L 2201/04; A47L 9/2805

(57) ABSTRACT

A robot cleaner includes: a main body configured to travel a cleaning area, and suck foreign substances from a floor of the cleaning area; an image acquisition unit configured to be disposed in the main body, and acquire an image of a certain area of the front of the main body; a first pattern irradiating unit configured to be disposed in the main body, and irradiate light of a first pattern downward into the area; and a second pattern irradiating unit configured to be disposed below the first pattern irradiating unit in the main body, and irradiate light of a second pattern upward into the area, wherein the first pattern includes a first horizontal line and a first vertical line intersecting with the first horizontal line, wherein the second pattern includes a second horizontal line and a second vertical line intersecting with the second horizontal line, wherein when the light of the first pattern and the light of the second pattern are incident on a certain vertical plane, a first intersection point and a second intersection point are first diagonally arranged in a quadrangle defined by the first horizontal line, the first vertical line, the second horizontal line, and the second vertical line.

### TECHNICAL FIELD

The present invention relates to an autonomous mobile robot cleaner.

### BACKGROUND ART

Generally, a robot cleaner is an apparatus that sucks foreign substances such as dust from the floor while traveling in a self-cleaning area without user's operation.

The robot cleaner detects obstacles such as furniture, office supplies, and walls installed in a cleaning area by itself to perform an obstacle avoiding operation or to map the cleaning area.

In recent years, a technology of irradiating light of a specific pattern toward the front of the robot cleaner so as to photograph an image, of extracting the pattern from the photographed image, and of determining the obstacle situation in the cleaning area based on the extracted pattern to control traveling has been applied. For example, Korean Patent Laid-Open Publication No. 10-2013-0141979 (hereinafter, referred to as ‘979 invention’) discloses a robot cleaner having a light source module for irradiating a cross pattern light and a camera module for acquiring an image of the front of the cleaner. Such a robot cleaner extracts a pattern from an image acquired through a camera module, and recognizes an obstacle situation in a cleaning area based on the extracted pattern. However, in the case of such a robot cleaner, since the light source module is configured to irradiate light at a certain angle and only a single light source module is provided, there is a restriction of the range in which the obstacle can be detected, and it is also difficult to determine the three-dimensional shape of the obstacle having a height. In particular, the '979 invention can not detect an obstacle positioned higher than the light source module or an obstacle whose height ranging from the floor reaches a point higher than the light source module, because the cross pattern is irradiated toward the floor of the cleaning area.

In the '979 invention, when a vertical line shape light emitted from the camera module is incident on the obstacle, the height of the obstacle may be measured to some extent, but thus acquirable obstacle information was limited to the part to which the vertical line pattern is irradiated.

Further, in the case of an obstacle such as a bed, since a mattress is mounted on the legs of the bed, a certain space may be formed below the mattress. Depending on the position of the robot cleaner with respect to the bed, all the light of the cross pattern irradiated from the light source module is irradiated to the floor in the space, and a control unit of the robot cleaner can not identify the mattress, and thus, may control the robot cleaner to continue traveling to the side of the bed. In this case, depending on the height of the space, the robot cleaner can not enter the space, and the robot cleaner may collide with a structure such as a frame supporting the mattress, or may be held between the floor and the frame. Accordingly, there is a problem that it is not able to travel any more.

In addition, in the case of the '979 invention, the shape of the obstacle to which the pattern light is emitted can be determined from the shape of the horizontal line displayed on the image. However, since information on the shape of the obstacle acquired through such method is limited to the area to which the horizontal line is emitted, the information that the robot cleaner can acquire from the current position is limited. For example, in order to acquire information on the overall shape ranging to the top/bottom of the obstacle, the robot cleaner must scan the obstacle by using the pattern light while moving or rotating.

### DISCLOSURE OF INVENTION

### Technical Problem

The present invention has been made in view of the above problems, and it is a first object of the present invention is to provide a robot cleaner that can acquire more detailed information on an obstacle by using patterns irradiated from two pattern irradiating units disposed vertically.

It is a second object of the present invention is to provide a robot cleaner for acquiring detailed information on the shape of an obstacle by using positional information of an intersection between a horizontal line and a vertical line constituting the pattern light irradiated from the pattern irradiating unit.

It is a third object of the present invention is to provide a robot cleaner for acquiring shape information on the entire of top and bottom sides of the front obstacle at a current position where the image is acquired and, in particular, when the upper portion of the obstacle is protruded to the lower portion or has a concave shape, provide a robot cleaner for determining such an image from the image acquired at the current position.

It is a fourth object of the present invention is to provide a robot cleaner for more accurately performing a wall following.

It is a fifth object of the present invention is to provide a robot cleaner for preventing an obstacle from being caught in the space while traveling, when the obstacle, such as a bed, that forms a space of a certain height exists between the obstacle and a floor of a cleaning area.

### Solution to Problem

In accordance with an aspect of the present invention, a robot cleaner includes: a main body, an image acquisition unit, a first pattern irradiating unit, and a second pattern irradiating unit.

The main body travels a cleaning area, and sucks foreign substances from a floor of the cleaning area, and the image acquisition unit configured to be disposed in the main body, and acquire an image of a certain area of the front of the main body.

The first pattern irradiating unit is disposed in the main body, and irradiates light of a first pattern downward into the area. The second pattern irradiating unit is disposed below the first pattern irradiating unit in the main body, and irradiates light of a second pattern upward into the area. The second pattern irradiating unit may be used to sense obstacles positioned above the first pattern irradiating unit.

The first pattern includes a first horizontal line and a first vertical line intersecting with the first horizontal line, and may be asymmetric with respect to the first vertical line. The first pattern may be asymmetric with respect to the first horizontal line.

The second pattern includes a second horizontal line and a second vertical line intersecting with the second horizontal line, and may be asymmetric with respect to the second vertical line. The second pattern may be asymmetric with respect to the second horizontal line.

When the light of the first pattern and the light of the second pattern are incident on a certain vertical plane, a first intersection point where the first horizontal line and the first vertical line intersect with each other and a second intersection point where the second horizontal line and the second vertical line intersect with each other are first diagonally arranged in a quadrangle defined by the first horizontal line, the first vertical line, the second horizontal line, and the second vertical line.

The first intersection point on the vertical plane is positioned below the second intersection point.

The robot cleaner may include a controller. The controller may determine a shape of an obstacle based on coordinate value of the first intersection point and the second intersection point in the image.

The controller may control the main body to travel along a wall on which the first intersection point and the second intersection point are incident based on coordinate value of the first intersection point and the second intersection point in the image.

A third intersection point where the first horizontal line and the second vertical line intersect with each other and a fourth intersection point where the second horizontal line and the first vertical line intersect with each other may be positioned on a second diagonal line of the quadrangle.

In accordance with another aspect of the present invention, when the light of the first pattern and the light of the second pattern are incident on a certain vertical plane, a first intersection point where the first horizontal line and the first vertical line intersect with each other is disposed below a second intersection point where the second horizontal line and the second vertical line, and the first intersection point and the second intersection point are horizontally spaced apart from each other.

In accordance with another aspect of the present invention, when the light of the first pattern and the light of the second pattern are incident on a certain vertical plane, the first pattern and the second pattern form a quadrangle.

### BRIEF DESCRIPTION OF DRAWINGS

The above and other objects, features and advantages of the present invention will be more apparent from the following detailed description in conjunction with the accompanying drawings, in which:

FIG. 1 is a perspective view of a robot cleaner according to an embodiment of the present invention;

FIG. 2 is a horizontal angle of view of the robot cleaner of FIG. 1;

FIG. 3 is a front view of the robot cleaner of FIG. 1;

FIG. 4 is a bottom view of the robot cleaner of FIG. 1;

FIG. 5 is a block diagram showing the main parts of the robot cleaner of FIG. 1;

FIG. 6A is a front view and FIG. 6B is a side view of an obstacle sensor;

FIG. 7 shows an irradiation range and an obstacle detection range of a sensor of an obstacle detection module;

FIG. 8 is a diagram showing the principle of generating pattern light by a pattern irradiating unit;

FIG. 9A shows a first pattern light and FIG. 9B shows a second pattern light;

FIG. 10 shows pattern lights incident on a certain vertical plane;

FIG. 11 shows a state in which pattern lights are incident on a first obstacle; and

FIG. 12 shows a state in which pattern lights are incident on a second obstacle.

### BEST MODE FOR CARRYING OUT THE INVENTION

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

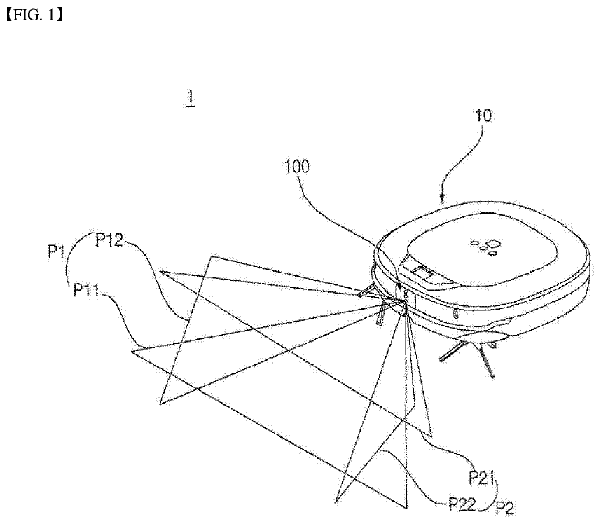

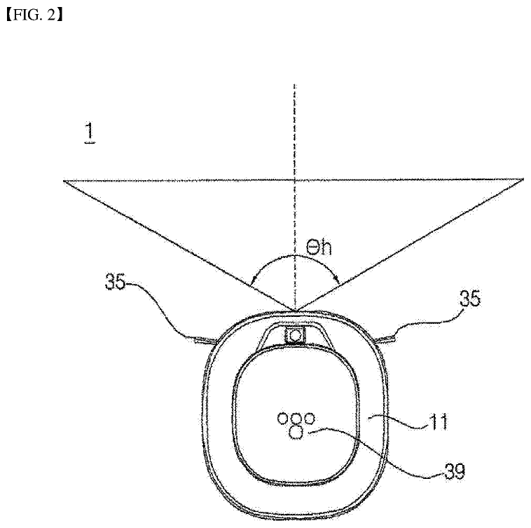

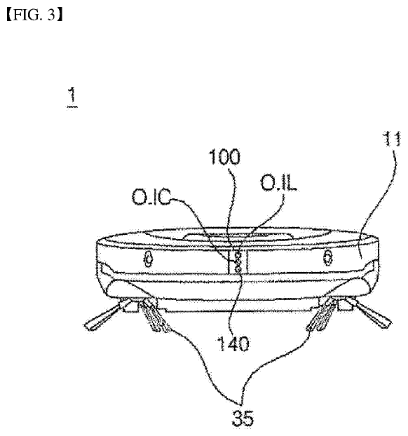

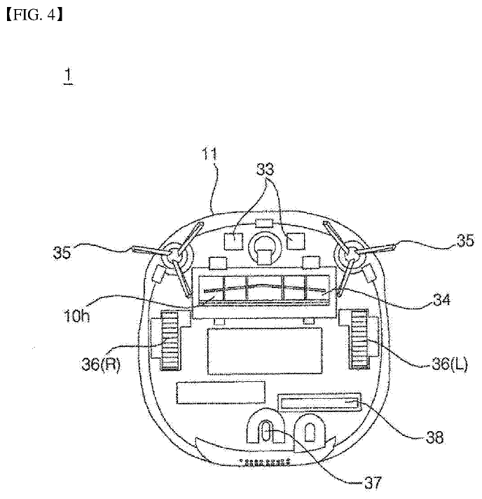

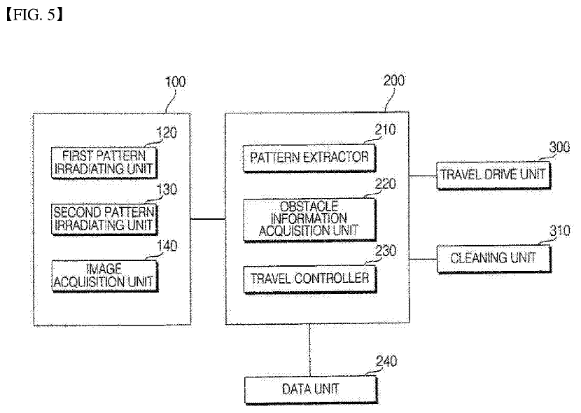

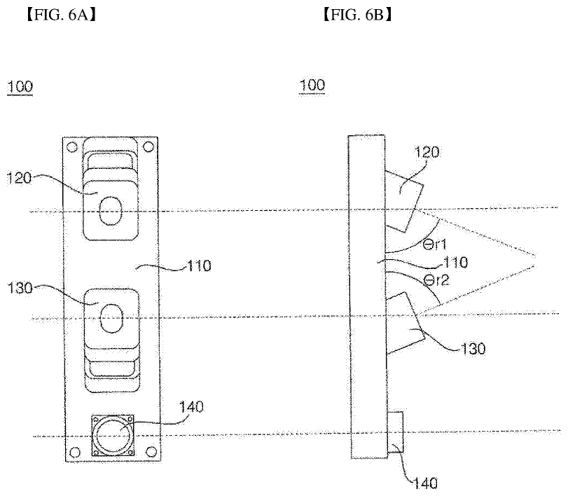

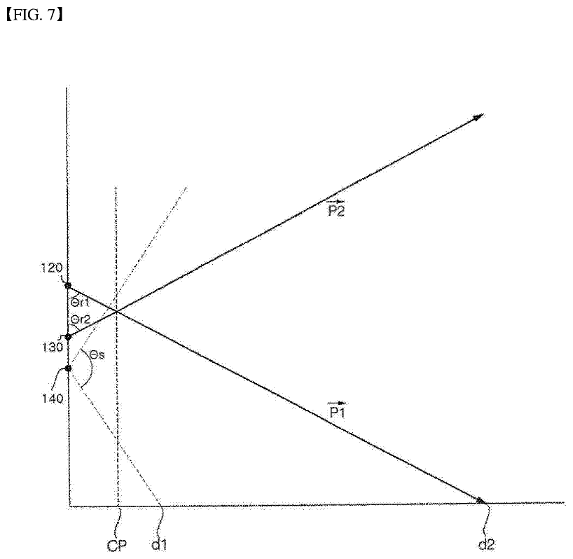

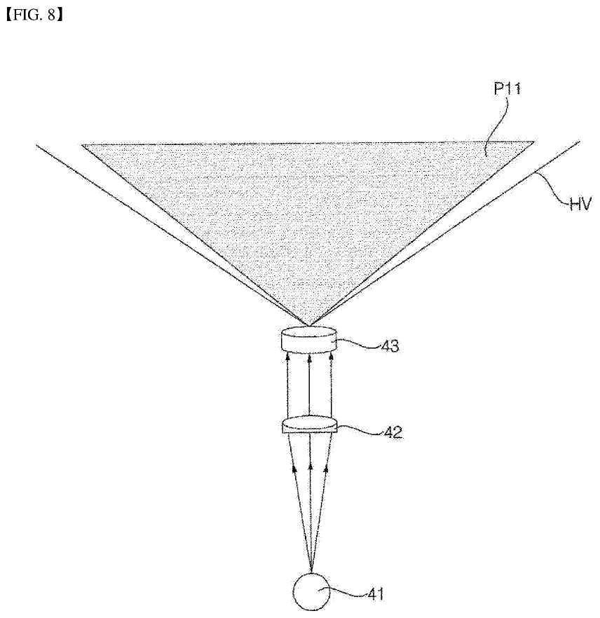

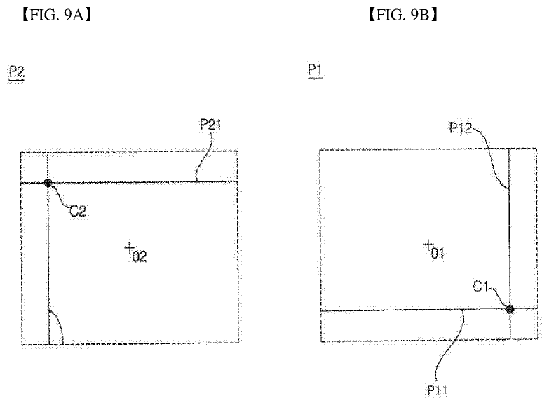

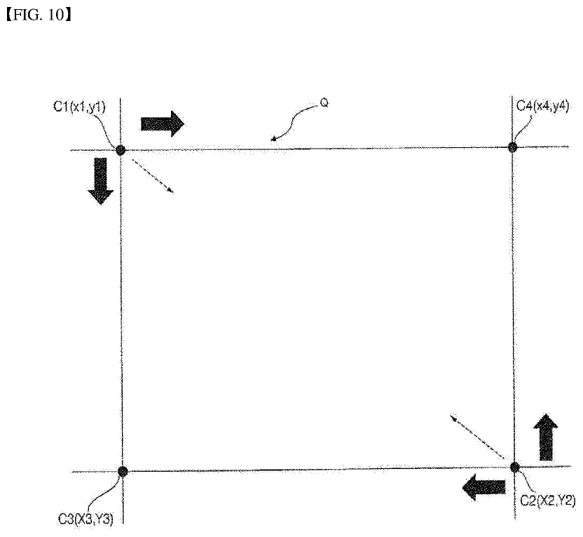

FIG. 1 is a perspective view of a robot cleaner according to an embodiment of the present invention. FIG. 2 is a horizontal angle of view of the robot cleaner of FIG. 1. FIG. 3 is a front view of the robot cleaner of FIG. 1. FIG. 4 is a bottom view of the robot cleaner of FIG. 1. FIG. 5 is a block diagram showing the main parts of the robot cleaner of FIG. 1. FIG. 6A is a front view and FIG. 6B is a side view of an obstacle sensor. FIG. 7 shows an irradiation range and an obstacle detection range of a sensor of an obstacle detection module. FIG. 8 is a diagram showing the principle of generating pattern light by a pattern irradiating unit. FIG. 9A shows a first pattern light and FIG. 9B shows a second pattern light. FIG. 10 shows pattern lights incident on a certain vertical plane;

Referring to FIGS. 1 to 10, a robot cleaner 1 according to an embodiment of the present invention may include a main body 10 moving along the bottom of a cleaning area and sucking foreign substances such as dust on the floor, and an obstacle sensor 100 disposed on the front of the main body 10.

The main body 10 may include a casing 11 defining an outer shape and forming a space for accommodating components constituting the main body 10 therein, a suction unit 34 disposed in the casing 11 for sucking foreign substances such as dust, and a left wheel 36(L) and a right wheel 36(R) which are rotatably provided in the casing 11. As the left wheel 36(L) and the right wheel 36(R) rotate, the main body 10 moves along the floor of the cleaning area, and foreign substances are sucked through the suction unit 34 in this process.

The suction unit 34 may include a suction fan (not shown) for generating a suction force and a suction port 10h for sucking the airflow generated by the rotation of the suction fan. The suction unit 34 may include a filter (not shown) for collecting foreign substances from the airflow sucked through the suction port 10h, and a foreign substances collecting box (not shown) in which foreign substances collected by the filter are accumulated.

In addition, the main body 10 may include a travel drive unit 300 for driving the left wheel 36(L) and the right wheel 36(R). The travel drive unit 300 may include at least one drive motor. The at least one drive motor may include a left wheel drive motor for rotating the left wheel 36(L) and a right wheel drive motor for rotating the right wheel 36(R).

The controller 200 may include a travel controller 230 for controlling the travel drive unit 300. The operation of the left wheel drive motor and the right wheel drive motor is controlled independently by the travel controller 230 so that the main body 10 can move forward, reverse, or turned. For example, when the main body 10 moves forward, the left wheel drive motor and the right wheel drive motor are rotated in the same direction. However, when the left wheel drive motor and the right wheel drive motor are rotated at different speeds, or rotated in opposite directions, the travel direction of the main body 10 can be changed. At least one auxiliary wheel 37 for stably supporting the main body 10 may be further provided.

In a data unit 240, acquired image inputted from the obstacle sensor 100 is stored, reference data that is used for an obstacle information acquisition unit 220 to determine an obstacle is stored, and obstacle information for the sensed obstacle is stored. In addition, in the data unit 240, control data for controlling the operation of the robot cleaner 1 and data related to a cleaning mode of the robot cleaner 1 is stored, and a map which is generated or is received from the outside can be stored.

A cleaning unit 310 operates a brush so that dust or foreign substances around the robot cleaner 1 can be easily sucked, and operates a suction device to suck dust or foreign substances. The cleaning unit 310 controls the operation of the suction fan provided in the suction unit 34 that sucks foreign substances such as dust or trash so that the dust is introduced into the foreign substances collecting box through the suction port.

In addition, the data unit 240 stores data that can be read by a microprocessor, and may include a hard disk drive (HDD), a solid state disk (SSD), a silicon disk drive (SDD), ROM, RAM, CD-ROM, magnetic tape, floppy disk, optical data storage device.

A plurality of brushes 35, which are located on the front side of the bottom surface of the casing 11 and have a plurality of radially extended feathering, may be further provided. The dusts are removed from the floor of the cleaning area by the rotation of the brushes 35, so that the dusts separated from the floor may be sucked through the suction port 10h and collected in the collecting box.

A control panel 39 for receiving various commands for controlling the robot cleaner 1 from a user may be provided on the upper surface of the casing 11.

The main body 10 is provided with a rechargeable battery 38. A charging terminal 33 of the battery 38 may be connected to a commercial power supply (e.g., a power outlet in a home), or the main body 10 may be docked to a separate charging stand (not shown) connected to the commercial power supply, so that the charging terminal 33 can be electrically connected to the commercial power supply and the battery 38 can be charged. Electric components constituting the robot cleaner 1 may be supplied with electric power from the battery 38. Therefore, when the battery 38 is charged, in a state of being electrically disconnected from the commercial power supply, the robot cleaner 1 is able to travel autonomously.

The obstacle sensor 100 may be disposed on the front surface of the main body 10. The obstacle sensor 100 includes a first pattern irradiating unit 120, a second pattern irradiating unit 130, and an image acquisition unit 140. The image acquisition unit 140 acquires an image of a certain area in front of the main body 10. The first pattern irradiating unit 120 irradiates the light of a first pattern downward into the area. The second pattern irradiating unit 130 is disposed below the first pattern irradiating unit 120 and irradiates the light of a second pattern upward into the area.

More specifically, referring to FIG. 6, the obstacle sensor 100 may further include a module frame 110 that is fixed to the front surface of the casing 11, and is elongated vertically. The first pattern irradiating unit 120, the second pattern irradiating unit 130, and the image acquisition unit 140 may be installed in the module frame 110. Depending on an embodiment, the first pattern irradiating unit 120, the second pattern irradiating unit 130, and/or the image acquisition unit 140 may be fixed directly to the casing 11 without the module frame 110.

Referring to FIG. 8, each of the pattern irradiating units 120 and 130 may include a light source 41 and an optical pattern projection element (OPPE) 43 for generating a certain pattern by transmitting the light irradiated from the light source 41.

In addition, the pattern irradiating units 120 and 130 may include a collimator for converting the light (FIG. 8 illustratively shows a first horizontal line P11) irradiated from the light source 41 into a linear light (or a parallel light). In particular, when the light source 41 is a point light source, a divergent light emitted from the light source 41 passes through the collimator 42 and is converted into linear light, and then may be incident on the optical pattern projection element 43. In FIG. 8, HW indicates a range in which an image is acquired by the image acquisition unit 140.

The laser light is superior to other light sources in monochromaticity, straightness, and connection characteristics, thereby enabling accurate distance measurement. Particularly, since the infrared ray or the visible ray has a problem that a deviation in the accuracy of the distance measurement is largely generated depending on the factors such as the color and the material of an object, it is preferable that a laser diode is used as the light source 41. In addition, the optical pattern projection element 43 may include a lens or a diffractive optical element (DOE). Light of various patterns may be implemented according to the configuration of the optical pattern projection element 43 provided in each of the irradiating units 120 and 130.

For example, Korean Patent Laid-Open Publication No. 10-2015-0050160 discloses a lens that changes the light irradiated from a light source into a cross pattern. The lens has convex cells on an incident surface on which the light irradiated from the light source is incident. The incident surface divides a light irradiated from the light source into a first area for converting the light into the horizontal line shape and a second area for converting the light into a vertical line shape. Vertical convex cells extending in the vertical direction in parallel to each other are formed in the first area, and horizontal convex cells extending in the horizontal direction in parallel to each other are formed in the second area. As in the present embodiment, the non-symmetrical cross pattern light may be formed by adjusting the shape, position or arrangement of the first area and the second area, or by adjusting the position on which light is incident on the incident surface of the lens. However, the present invention is not limited thereto, and various known methods can be used.

Meanwhile, the first pattern irradiating unit 120 may irradiate the light of a first pattern P1 (hereinafter, referred to as a first pattern light) toward the front lower side of the main body 10. Accordingly, the first pattern light P1 may be incident toward the floor of the cleaning area. The first pattern light P1 may be formed in the form of a cross pattern in which a first horizontal line P11 and a first vertical line P12 intersect with each other. Preferably, the cross pattern is asymmetric with respect to the first horizontal line P11 or is asymmetric with respect to the first vertical line P12, and more preferably, is asymmetric with respect to both the first horizontal line P11 and the first vertical line P12 as in the embodiment.

Similarly, a second pattern light P2 may be formed in the form of a cross pattern in which a second horizontal line P12 and a second vertical line P22 intersect. Preferably, the cross pattern is asymmetric with respect to the second horizontal line P21 or is asymmetric with respect to the second vertical line P22, and more preferably, is asymmetric with respect to both the second horizontal line P21 and the second vertical line P22 as in the embodiment.

The first pattern irradiating unit 120, the second pattern irradiating unit 130, and the image acquisition unit 140 may be disposed in a line. Preferably, the first pattern irradiating unit 120, the second pattern irradiating unit 130, and the image acquisition unit 140 are disposed in sequence from top to bottom, but are not limited thereto.

The first pattern irradiating unit 120 irradiates the first pattern light P1 downward toward the front, and senses obstacles positioned below the first pattern irradiating unit 120, and the second pattern irradiating unit 130 is positioned below the first pattern irradiating unit 120, and irradiates the light of a second pattern P2 (hereinafter, referred to as second pattern light) upward toward the front. Accordingly, the second pattern light P2 may be incident on the obstacle, a certain portion of the obstacle, or the wall surface positioned at least higher than the second pattern irradiating unit 130 from the floor of the cleaning area.

In FIGS. 9, O1 and O2 indicate the centers of the areas (quadrangle indicated by dotted lines) to which the first pattern light P1 and the second pattern light P2 are irradiated, respectively. The irradiation directions of the pattern lights P1 and P2 are defined by the directions of the pattern irradiating units 120 and 130 toward the centers O1 and O2, and straight lines following these directions are shown in FIGS. 7 as (P1) ? and (P2) ?.

As shown in FIG. 7, when viewed from the side of the main body 10, a path (P1) ? through which the first pattern light P1 is irradiated and a path (P2) ? through which the second pattern light P2 is irradiated intersect with each other. CP is a point where the path (P1) ? through which the first pattern light P1 is irradiated and the path (P2) ? through which the second pattern light P2 is irradiated are intersected. The point CP may be positioned closer to the body 10 than a point d2 on a floor BT where the acquisition unit 140 begins to acquire image.

Meanwhile, θh shown in FIG. 2 indicates a horizontal irradiation angle of the pattern light P1 irradiated from the first pattern irradiating unit 120, indicates an angle formed by both ends of the horizontal line Ph with respect to the first pattern irradiating unit 120, and is preferably set in a range of 130 to 140 degrees, but is not limited thereto. The dotted line shown in FIG. 2 is directed toward the front of the robot cleaner 1, and the first pattern light P1 may be formed asymmetrically with respect to the dotted line.

Similarly to the first pattern irradiating unit 120, the horizontal irradiation angle of the second pattern irradiating unit 130 may also be set, preferably, in the range of 130 to 140 degrees. In some embodiments, the pattern light P2 may be irradiated at the same horizontal irradiation angle as that of the first pattern irradiating unit 120. In this case, the second pattern light P1 may also be formed asymmetric with respect to the dotted line shown in FIG. 2.

When the first pattern light P1 and the second pattern light P2 are incident on a certain vertical plane, a quadrangle Q is defined by the pattern light P1 and P2. Here, in FIG. 7, the vertical plane may be defined between a point CP at which the direction in which the first pattern light P1 is irradiated and the direction in which the second pattern light P2 is irradiated are intersected with each other to a point (i.e., a point d2 where (P1) ? meets a bottom BT in FIG. 7) at which the direction in which the first pattern light P1 is irradiated indicates a bottom.

The quadrangle Q is defined by a first horizontal line P11, a second vertical line P12, a second horizontal line P21, and a second vertical line P22. Four vertexes of the quadrangle Q are formed by the first horizontal line P11, the first vertical line P12, the second horizontal line P21, and the second vertical line P22. A first intersection point C1 at which the first horizontal line P11 intersects with the first vertical line P12 and a second intersection point C2 at which the second horizontal line P21 intersects with the second vertical line are first diagonally arranged in the quadrangle Q.

Meanwhile, in some embodiments, since the first pattern light P1 and the second pattern light P2 do not intersect with each other, the vertexes C3 and/or C4 may not be generated. In this case, the vertexes C3 and C4 in the quadrangle Q are intersection points where the horizontal line and/or the vertical line constituting the first pattern light P1 and the second pattern light P2 are extend to meet each other.

The image acquisition unit 140 may acquire an image of the front of the main body 10. Particularly, the pattern light P1 and P2 appears in the image (hereinafter, referred to as an “acquisition image”) acquired by the image acquisition unit 140. Hereinafter, an image of the pattern light P1 or P2 appeared in the acquisition image is referred to as a light pattern. Since this is substantially an image, which is formed on the image sensor, of the pattern lights P1 and P2 incident on the actual space, the same reference numerals as the pattern lights P1 and P2 are given. Thus, the phases corresponding to the first pattern light P1 and the second pattern light P2 are referred to as a first light pattern P1 and a second light pattern P2, respectively. The image acquisition unit 140 may include a digital camera that converts an image of an object into an electrical signal, converts the electrical signal again into a digital signal, and stores the digital signal in a memory device. The digital camera may include a lens (not shown), an image sensor (not shown), and an image processing module (not shown).

The image sensor is an apparatus for converting an optical image into an electrical signal. The image sensor is composed of a chip on which a plurality of photo diodes are integrated, and the photodiode may be, for example, a pixel. Charges are accumulated in respective pixels by an image formed on the chip due to the light passed through the lens, and the charges accumulated in the pixel are converted into an electrical signal (e.g., voltage). As the image sensor, a Charge Coupled Device (CCD), a Complementary Metal Oxide Semiconductor (CMOS), and the like are well known.

The image processing module generates a digital image based on an analog signal outputted from the image sensor. The image processing module may include an AD converter for converting the analog signal into a digital signal, a buffer memory for temporarily storing digital data according to the digital signal outputted from the AD converter, and a digital signal processor (DSP) for processing the data stored in the buffer memory to construct a digital image.

In addition, the robot cleaner 1 may include a data storage unit (not shown) that stores data that can be read by a microprocessor, for example, a hard disk drive (HDD), a solid state disk (SSD), a silicon disk drive (SDD), a ROM, a RAM, a CD-ROM, a magnetic tape, a floppy disk, an optical data storage device, and the like.

In the acquisition image, the horizontal line P11 and P21 and the vertical line P12 and P22 may be distorted due to the physical characteristics of the lens constituting the image processing module. In this case, the quadrangle acquired from the acquisition image is not defined as a quadrangle on a plane in the strict sense as each side has a curved shape (i.e., a shape similar to a case where a quadrangle is drawn on a curved surface). However, even in this case, the four vertexes of the line segments can be clearly derived, and thus, this form is also defined as a square (Q).

The controller 200 may include a pattern extractor 210 for detecting the light pattern P1 and P2 from the image (acquisition image) acquired by the image acquisition unit 140. The pattern extractor 210 detects feature such as a point, a line, and a surface with respect to certain pixels constituting the acquisition image, and detects the light pattern P1, P2 or a point, a line, a plane, and the like constituting the light pattern P1 and P2 based on the detected features. For example, the pattern extractor 210 may extract the horizontal line P11 and P12 and the vertical line P21 and P22 by extracting line segments constituted by successive pixels that are brighter than the surroundings.

In particular, since the intersection points C1, C2, C3, and c4, which are generated as the horizontal lines P11 and P21 and the vertical lines P21 and P22 are intersected, are brighter than the surroundings, the controller 200 may detect one or more feature points C1, C2, C3 and C4 which are brighter in brightness than the surroundings among a plurality of pixels constituting the horizontal line P11, P21 or the vertical line P12, P22 as the intersection points C1, C2, C3, and c4.

However, the present invention is not limited thereto, and various techniques for extracting a desired pattern from a digital image are already known. Accordingly, the pattern extractor 210 may extract the first light pattern P1 and the second light pattern P2 by using these known technologies.

Hereinafter, the angle formed by the irradiation direction of the first pattern irradiating unit 120 or the second pattern irradiating unit 130 with respect to the horizontal is defined as a vertical irradiation angle. Specifically, the vertical irradiation angle may be defined as an angle formed by the direction of the optical axis of the lenses constituting the pattern irradiating units 120 and 130 with respect to the horizontal. Here, the optical axis of the lenses pass through the centers O1 and O2 shown in FIG. 9, respectively.

The first pattern irradiating unit 120 and the second pattern irradiating unit 130 may be disposed vertically symmetrically. Preferably, the first pattern irradiating unit 120 and the second pattern irradiating unit 130 are disposed on a certain vertical line, the first pattern irradiating unit 120 irradiates the first pattern light P1 downward with a first vertical irradiation angle θr, and the second pattern irradiating unit 130 irradiates the second pattern light P2 upward with a second vertical irradiation angle θr of the same magnitude.

When the pattern light irradiated from the first pattern irradiating unit 120 and/or the second pattern irradiating unit 130 is incident on the obstacle, the position of the light patterns P1 and P2 in the acquisition image is changed, depending on the position of the obstacle away from the first pattern irradiating unit 120. For example, when the first pattern light P1 and the second pattern light P2 are incident on a certain obstacle, the closer the obstacle is located from the robot cleaner 1, the first light pattern P1 ? particularly, the horizontal line P11—is displayed at a high position in the acquisition image, whereas the horizontal line P21 of the second light pattern P2 is displayed at a low position. That is, after distance data to the obstacle corresponding to the row (line consisting of the pixels arranged in the horizontal direction) constituting the image generated by the image acquisition unit 140 is previously stored, when the light pattern P1 and P2 detected in the image acquired through the image acquisition unit 140 is detected from a certain row, the position of the obstacle can be estimated from the distance data to the obstacle corresponding to the row.

Meanwhile, the image acquisition unit 140 may be arranged such that the optical axis of the lens is oriented in a horizontal direction. θs shown in FIG. 7 indicates the angle of view of the image acquisition unit 140, and is set to a value of 100 degrees or more, preferably, 100 to 110 degrees, but it is not necessarily limited thereto.

In FIG. 4, the floor of the cleaning area in the image acquired by the image acquisition unit 140 appears after a point indicated as d2. When the vertical plane is positioned between the point CP and d2, a quadrangle Q defined by the first pattern light P1 and the second pattern light P2 is formed in an erected form on the vertical plane.

For reference, when the vertical plane is located at a position closer to the robot cleaner 1 than the point CP, a quadrangle Q defined by the first pattern light P1 and the second pattern light P2 is formed on the vertical plane in a reverse image. (i.e., inverted form) of the erected form.

In addition, in FIG. 7, S1 (the area ranging from the robot cleaner 1 to the point d1) indicates an area in which the positions of the first light pattern P1 and the second light pattern P2 are reversed. When an obstacle is positioned within the area S1, the first horizontal line P11 is positioned above the second horizontal line P21 in the acquisition image.

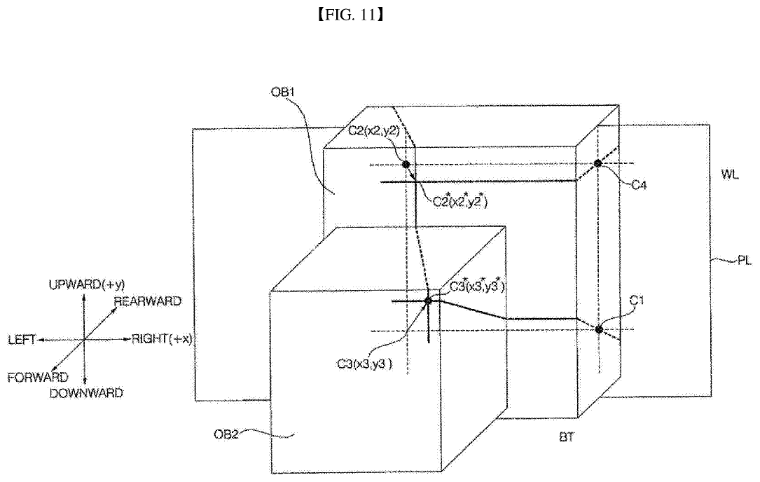

FIG. 11 shows a state in which pattern lights are incident on a first obstacle. Referring to FIG. 11, the controller 200 may acquire information on an obstacle based on the shape or position of the pattern light P1, P2 shown in the acquisition image.

The vertical plane PL is positioned between the point CP and the point d2 in FIG. 7. The lattice in the form of [symbol] shape shown by the dotted line is a shape of the pattern light P1 and P2 incident on the vertical plane PL, when a first obstacle OB1, OB2 does not exist between the robot cleaner 1 and the vertical plane PL. The first obstacle OB1, OB2 include a first part OB1 and a second part OB2 protruding forward from a lower portion of the first part OB1.

In this case, the first pattern light P1 is irradiated downward from the front side of the obstacle OB1, OB2 to the rear side, and the second pattern light P1 is irradiated upward from the front side f the obstacle OB1, OB2 to the rear side.

BT is a floor on which the robot cleaner 1 travels, and WL is a wall perpendicular to the floor and positioned in the rear side of the obstacle OB1, OB2.

In the lattice shown by the dotted line, the first intersection point C1 is positioned on a fourth quadrant when defining a XY orthogonal coordinates system at the center of the lattice, and the second intersection point C2 is positioned on a second quadrant.

In addition, the third intersection point C3 is positioned on a third quadrant, and the fourth intersection point C4 is positioned on a first quadrant. The second intersection point C3 and the fourth intersection point C4 may be positioned on a second diagonal line (a diagonal line intersecting the first diagonal line) of the quadrangle Q.

Meanwhile, when the first obstacles OB1, OB2 exists between the point CP (see FIG. 7) and the vertical plane PL, in the pattern displayed in the obstacle OB1, OB2, in comparison with the lattice indicated by the dotted line, the first horizontal line P11 is moved in the upward direction (+Y), the second horizontal line P21 is moved in the downward direction (−Y), the first vertical line P12 is moved in the left direction (−X), and the second vertical line P22 is moved in the right direction (+X).

However, since the second part OB2 protrudes further forward than the first part OB1, a part of the first horizontal line P11 incident on the second part OB2 is moved further upward than the other part of the first horizontal line P11 incident on the first part OB1, and a part of the second horizontal line P12 incident on the second part OB2 is moved to the right of the other part of the first horizontal line P11 incident on the first part OB1.

Based on the position or coordinate (C1*, C3*, in the embodiment) of the intersection point acquired from the acquisition image, the controller 200 may determine that the shape of the obstacle is configured to include the first part OB1 and the second part OB2 protruding from the first part OB1.

In particular, specific information on the shape of the obstacle OB1, OB2 may be directly acquired from the acquisition image at the current position. Specifically, it is possible to determine whether the portion where a certain intersection point is positioned is located forward or rearward in comparison with the portion where the other intersection point is positioned, i.e., the relative position between the intersection points, from the coordinate values of two or more intersection points appeared in the acquisition image. This process can be performed without an obstacle scan through rotation or movement of the main body 10.

Meanwhile, in the embodiment, although it is described that the protruded portion OB1 of the obstacle is detected based on the coordinate value (x3, y3) of the third intersection point C3* in the acquisition image, it is obvious that the shape of the obstacle can be determined based on the coordinate value of the other intersection points C1, C2, and C4 in the acquisition image. For reference, as the distance between the robot cleaner 1 and the obstacle decreases, FIG. 10 shows that the displacement of the horizontal line P11, P21 and the vertical line P12, P22 displayed on the acquisition image is indicated as a thick arrow, and the displacement of the first intersection point C1 and the second intersection point C2 as a result of the combination of the displacement of the horizontal line P11, P21 and the vertical line P12, P22 is indicated as a dotted line.

The controller 200 may control the main body 10 to travel along the wall WL on which the first intersection point C1 and the second intersection point C2 are incident, based on the coordinate of the first intersection point C1 and the second intersection point C2 in the acquisition image. This wall following may be achieved based on the coordinate value of the third intersection point C3 and/or the fourth intersection point C4. Since the shape of the point C1, C2, C3, and C4 incident on the wall WL is not significantly changed, and only the position varies depending on the shape of the wall WL or the distance to the wall WL, it is easy for the robot cleaner 1 to follow the points C1, C2, C3, and C4 in the acquisition image to travel. Accordingly, the wall-following travel can be accurately performed.

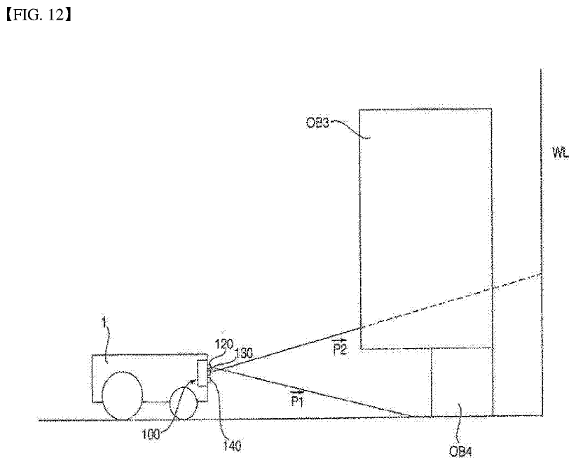

FIG. 12 shows a state in which pattern lights are incident on a second obstacle. Referring to FIG. 12, the second obstacle OB3, OB4 includes a second part OB4 forming a rearwardly recessed space below the first part OB3. The shape of the obstacle corresponds to a case where a frame is supported by legs like a bed and thus a space is formed below the frame.

As shown in FIG. 12, the first pattern light P1 reaches into the space below the first obstacle OB3, and the second pattern light P2 is incident on the first part OB1.

At this time, since the first pattern light P1 is incident on the bottom BT, the first horizontal line P11 shall be exist at a reference position (the position represented in the acquisition image when the first pattern light P1 is irradiated on the floor where the robot cleaner 1 is positioned) in the acquisition image. In addition, the first vertical line P12 of the first pattern light P1 may be entirely incident on the floor BT, or may partially reach the second part OB4. The controller 200 may determine the depth of the space below the first part OB1 based on the position of the first vertical line P12 in the acquisition image.

In addition, the controller 200 may determine the distance from the robot cleaner 1 to the first part OB1, and the height or shape of the first part OB1, from the position of the second pattern light P2 in the acquisition image.

As described above, the robot cleaner 1 according to the present embodiment may determine an obstacle having a certain lower side space from the position (or shape) of the first pattern light P1 and the second pattern light P2 acquired from the acquisition image.

The robot cleaner of the present invention has the following effects. Firstly, it may acquire more specific information on the obstacle by using the patterns irradiated from the two pattern irradiating units disposed vertically. Particularly, it can determine a concrete form at the upper part and the lower part of the obstacle.

Secondly, it may acquire concrete information on the shape of the obstacle by using the position information of the intersection point of the horizontal line and the vertical line constituting the pattern light. In particular, since the intersection points are two or more, the shape of the obstacle near each intersection point can be determined based on the relative position of other intersection point with respect to the intersection point.

Third, the morphological information of the entire upper and lower parts of the front obstacle can be acquired at the current position where the image is acquired. If the upper part is protruded or concave to the lower part, information on the obstacle can be determined based on the image acquired from the current position. Therefore, the robot cleaner is moved or rotated to make the pattern light scan the obstacle, thereby acquiring information about the obstacle more efficiently than the related art.

Fourth, there is an effect that the wall following operation can be performed more accurately.

Fifth, when there is an obstacle, such as a bed, which forms a space of a certain height between the floor of the cleaning area and the obstacle, the robot cleaner can be prevented from being caught in the space during traveling.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Accordingly, the scope of the present invention is not construed as being limited to the described embodiments but is defined by the appended claims as well as equivalents thereto.

1. A robot cleaner comprising:
a main body configured to travel a cleaning area, and suck foreign substances from a floor of the cleaning area;
an image acquisition unit configured to be disposed in the main body, and acquire an image of a certain area of the front of the main body;
a first pattern irradiating unit configured to be disposed in the main body, and irradiate light of a first pattern downward into the area; and
a second pattern irradiating unit configured to be disposed below the first pattern irradiating unit in the main body, and irradiate light of a second pattern upward into the area,
wherein the first pattern includes a first horizontal line and a first vertical line intersecting with the first horizontal line,
wherein the second pattern includes a second horizontal line and a second vertical line intersecting with the second horizontal line,
wherein when the light of the first pattern and the light of the second pattern are incident on a certain vertical plane, a first intersection point where the first horizontal line and the first vertical line intersect with each other and a second intersection point where the second horizontal line and the second vertical line intersect with each other are first diagonally arranged in a quadrangle defined by the first horizontal line, the first vertical line, the second horizontal line, and the second vertical line.

2. The robot cleaner of claim 1, wherein the first intersection point on the vertical plane is positioned below the second intersection point.

3. The robot cleaner of claim 2, wherein the first pattern is asymmetric with respect to the first vertical line.

4. The robot cleaner of claim 1, wherein the first pattern is asymmetric with respect to the first horizontal line.

5. The robot cleaner of claim 1, wherein the second pattern is asymmetric with respect to the second vertical line.

6. The robot cleaner of claim 1, wherein the second pattern is asymmetric with respect to the second horizontal line.

7. The robot cleaner of claim 1, further comprising a controller configured to determine a shape of an obstacle based on coordinate value of the first intersection point and the second intersection point in the image.

8. The robot cleaner of claim 1, further comprising a controller configured to control the main body to travel along a wall on which the first intersection point and the second intersection point are incident based on coordinate value of the first intersection point and the second intersection point in the image.

9. The robot cleaner of claim 1, wherein a third intersection point where the first horizontal line and the second vertical line intersect with each other and a fourth intersection point where the second horizontal line and the first vertical line intersect with each other are positioned on a second diagonal line of the quadrangle.

10. The robot cleaner of claim 1, wherein a path through which light of the first pattern is irradiated and a path through which light of the second pattern is irradiated intersect with each other, when viewed from the side of the main body.

11. The robot cleaner of claim 10, wherein a point where the path through which light of the first pattern is irradiated and the path through which light of the second pattern is irradiated intersect with each other, is positioned at a point closer to the body than a point on the floor where the image acquisition unit begins to acquire image.

12. The robot cleaner of claim 12, wherein the first pattern irradiating unit, the second pattern irradiating unit, and the image acquisition unit are disposed in a line in a vertical direction on a front surface of the main body.

13. The robot cleaner of claim 12, wherein the first pattern irradiating unit, the second pattern irradiating unit, and the image acquisition unit are sequentially disposed from the upper side to the lower side.

14. A robot cleaner comprising:
a main body configured to travel a cleaning area, and suck foreign substances from a floor of the cleaning area;
an image acquisition unit configured to be disposed in the main body, and acquire an image of a certain area of the front of the main body;
a first pattern irradiating unit configured to be disposed in the main body, and irradiate light of a first pattern downward into the area; and
a second pattern irradiating unit configured to be disposed below the first pattern irradiating unit in the main body, and irradiate light of a second pattern upward into the area,
wherein the first pattern includes a first horizontal line and a first vertical line intersecting with the first horizontal line,
wherein the second pattern includes a second horizontal line and a second vertical line intersecting with the second horizontal line,
wherein when the light of the first pattern and the light of the second pattern are incident on a certain vertical plane, a first intersection point where the first horizontal line and the first vertical line intersect with each other is disposed below a second intersection point where the second horizontal line and the second vertical line, and the first intersection point and the second intersection point are horizontally spaced apart from each other.

15. A robot cleaner comprising:
a main body configured to travel a cleaning area, and suck foreign substances from a floor of the cleaning area;
an image acquisition unit configured to be disposed in the main body, and acquire an image of a certain area of the front of the main body;
a first pattern irradiating unit configured to be disposed in the main body, and irradiate light of a first pattern downward into the area; and
a second pattern irradiating unit configured to be disposed below the first pattern irradiating unit in the main body, and irradiate light of a second pattern upward into the area,
wherein the first pattern and the second pattern form a quadrangle, when the light of the first pattern and the light of the second pattern are incident on a certain vertical plane.
